(19) United States
(12) Patent Application Publication
(10) Pub. No.: US 2008/0098321 A1
(43) Pub. Date: Apr. 24, 2008

(54) Method and apparatus for in-band discovery of capabilities of managed devices

(76) Inventor: Ramamurthy Krithivas, Chandler, AZ (US)

Correspondence Address: INTEL CORPORATION;c/o INTELLEVATE, LLC, P.O. BOX 52050, MINNEAPOLIS, MN, 55402, US

(21) Appl. No.: 11/584,459

(22) Filed: Oct. 19, 2006

(51) Int. Cl. G06F 15/16

(52) U.S. Cl. 715/771; 715/740; 709/217

(57) ABSTRACT

An in-band mechanism for discovery of device management capabilities is provided. The in-band discovery mechanism is similar to an out-of-band discovery mechanism and uses a non-proprietary mechanism. A management provider may query the management capabilities of devices and may register devices that may only be managed in-band with a directory agent.

### FIELD

This disclosure relates to management of storage devices and in particular to in-band management of storage devices.

### BACKGROUND

A storage area network (SAN) is a high-speed network that interconnects different types of storage elements with servers and provides a shared storage pool for servers (hosts) connected to the SAN. The storage elements may include storage arrays, switches, expanders, volume managers, Host Bus Adapters (HBAs) and Redundant Arrays of Independent Disks (RAID).

A Redundant Array of Independent Disks (RAID) combines a plurality of physical hard disk drives into a logical drive for purposes of reliability, capacity, or performance. Thus, instead of multiple physical hard disk drives, an operating system sees the logical drive.

The Storage Management Initiative-Specification (SMI-S) is a storage standard developed and maintained by the Storage Networking Industry Association (SNIA) and ratified as American National Standards Institute (ANSI) standard ANSI International Committee For Information Technology Standards (INCITS) 388-2004. SMI-S is an object orientated, platform independent standard for managing storage elements in a SAN based upon a Common Information Model (CIM) and Web-Based Enterprise Management (WBEM) standards (using Extensible Markup Language (XML) over Hyper Text Transfer Protocol (HTTP)) defined by the Distributed Management Task Force (DTMF). SMI-S also provides security and automated discovery of storage elements coupled to a SAN. SMI-S allows storage elements to be managed through out-of-band connections.

Management of a storage array is typically performed out-of-band over a local area network separate from the SAN. Devices such as the storage array may advertise their presence and manageability capabilities using the Service Location Protocol (SLP) which is an Internet Engineering Task Force (IETF) defined mechanism to advertise the capabilities of any managed device. An SLP template (SLP formatted data) enables a device to publish the availability of any service including manageability, and associated capabilities/attributes to directory agents. Management clients discover the managed devices by querying a directory agent. Discovery involves the retrieval of attributes such as Transmission Control Protocol (TCP)/Internet Protocol (IP) address and port number of the managed device to connect to, which is available in the SLP formatted data registered by the managed device with the directory agent.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a system that includes a host and a redundant array of independent disks coupled to a storage area network;

FIG. 2 is a block diagram of a Small Computer Systems Interface (SCSI) Inquiry command;

FIG. 3 is a block diagram illustrating an embodiment of the format of Inquiry data returned by a target device in response to the SCSI Inquiry command;

FIG. 4 is a block diagram illustrating in-band management and out-of-band management of an external Redundant Array of Independent Disks (RAID) array in a Small Computer Systems Interface (SCSI) domain;

FIG. 5 is a block diagram illustrating an embodiment of an SLP template that includes a plurality of attributes;

FIG. 6 is a flowchart illustrating an embodiment of a method for in-band discovery of device management capabilities according to the principles of the present invention; and

FIG. 7 is a block diagram of an embedded controller that performs in-band discovery of device management capabilities.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

In an embodiment of the present invention, manageability capabilities of a storage device stored as Service location Protocol (SLP) formatted data in the storage device may be retrieved using an in-band mechanism.

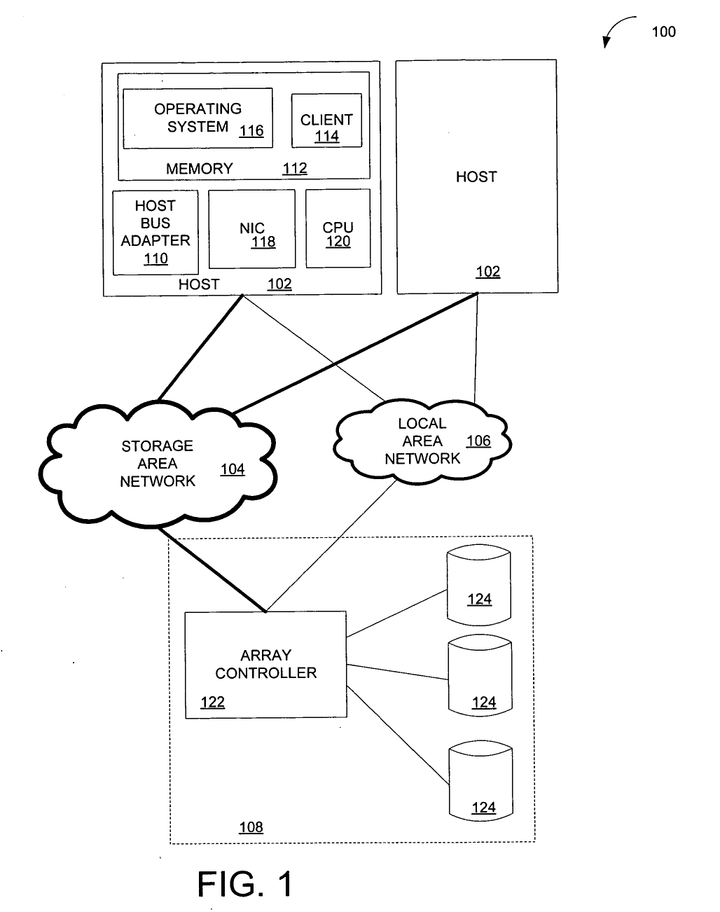

FIG. 1 is a block diagram of a system 100 that includes a host 102 and a redundant array of independent disks (RAID) array 108 coupled to a storage area network (SAN) 104. The host 102 includes a host bus adapter (HBA) 110, a Central Processing Unit (CPU) 120, a network interface controller (NIC) 118, and memory 112 capable of storing a client 114 and an operating system (OS) 116. The OS 116 manages a file system that manages files which may be stored in the RAID array 108. The client 114 is a process that issues requests for service through the HBA 110 to the RAID array 108. The HBA 110 manages communication between the host 102 and devices such as the RAID array 108 through the SAN 104.

The system shown in FIG. 1 includes two hosts 102, and each host 102 may access the RAID array 108 through the SAN 104, that is, in-band. Each of the hosts 102 may also access the RAID array 108 through a local area network (LAN) 106, that is, out-of-band. In-band and out-of band accesses differ in that in-band accesses are directed through the HBA 110 in the host 102 using a storage protocol and out-of-band access are directed through the NIC 118 in the host 102 over the LAN 106 using a Transmission Control Protocol (TCP)/Internet Protocol (IP) stack. Out-of-band access is typically used to manage the RAID array 108, that is, a separate network (LAN 106) is maintained for management access and control. The RAID array may be managed in-band, that is, control and management data share the same network (SAN 104) as the data being processed.

The RAID array 108 has front end ports connected to hosts 102 through the SAN 104 and backend ports connected to hard disk drives 124 managed by an array controller 122.

The RAID array 108 includes an array controller 122 and a plurality of hard disk drives (hard drives) 124. The array controller 122 manages the plurality of hard disk drives 124 which may be aggregated into a single logical storage unit. As is well known to those skilled in the art, there are many standard methods for distributing data across a logical storage unit. These methods are referred to as RAID levels. The array controller 122 may distribute data across the set of hard disk drives based on one of a plurality of RAID levels.

For example, in RAID level 0 data is striped across the physical array of hard disk drives by breaking data into blocks and writing each block to a separate hard disk drive. Input/Output (I/O) performance is improved by spreading the load across many hard disk drives. However, RAID level 0 does not provide redundancy, that is, if one hard disk drive fails all data is lost. Thus, RAID level 0 improves I/O performance but does not provide redundancy.

RAID level 5 provides a high level of redundancy by striping both data and parity information across at least three hard disk drives. Data striping is combined with distributed parity to provide a recovery path in case of failure.

The SAN 104 is a high-speed network that is dedicated to providing a high-speed connection between hosts 102 and storage elements. The hosts 102 and storage elements communicate over the SAN 104 using one of a plurality of Small Computer System Interface (SCSI) protocol suites, for example, Internet Small Computer Systems Interface (iSCSI), Serial Small Computer Systems Interface Protocol (SSP) and Fibre Channel Protocol (FCP).

A version of the Fibre Channel standard is described in the American National Standards Institute (ANSI) Standard Fibre Channel Framing and Signaling Interface-2 (FC-FS-2) Aug. 9, 2005 Specification. A version of the Fibre Channel Protocol (FCP-3) standard which defines a mapping protocol for applying the Small Computer System Interface (SCSI) command set to Fibre Channel is described in Information technology—Fibre Channel Protocol for SCSI, Third Version (FCP-3) Revision 4, Sep. 13, 2005 American National Standards Institute (ANSI) (hereinafter termed the “FCP standard”). A version of the Serial Attached Small Computer System Interface (SAS) protocol is described in “Information Technology—Serial Attached SCSI—1.1,” ANSI International Committee For Information Technology Standards (INCITS) 417-2006 (International Organization for Standardization(ISO)/International Electrotechnical Commission (IEC) 14776-151)(hereinafter termed the “SAS Standard”).

T10 is an ANSI body responsible for developing SCSI Standards that include SCSI Architecture Model (SAM), SCSI Primary Commands (SPC), SCSI Block Commands (SBC), Serial Attached SCSI (SAS), SES (SCSI Enclosure Standard), and SCC (SCSI Controller Commands). SCC Enables RAID Management and SEC Enables Enclosure Management for Storage Arrays. SCSI Addressing methods are described in the ANSI SCSI Architecture Model (SAM) standard.

A version of the iSCSI protocol is described in “Internet Small Computer System Interface”, Request for Comments (RFC) 3720 available from the Internet Engineering Task Force (IETF) at www.ietf.org (hereinafter termed the “iSCSI standard”). A version of the SCSI protocol for block-oriented direct-access devices such as magnetic disk drives is described in ANSI INCITS 351-2001 “SCSI Primary Commands-2 (SPC-2) and ANSI INCITS 405-2005 “SCSI Block Commands-2 (SBC-2)”. iSCSI encapsulates the SCSI protocol in an Internet Protocol (IP) packet that is transmitted using the IP protocol over the network.

The serial attached storage protocols provide a connection-orientated class of service between devices. Typically, in a serial attached storage protocol, a connection is established between an initiator (originator) and a target (responder). The initiator may be a storage protocol controller such as a Host Bus Adapter (HBA) and the target may be a storage device, for example, a hard disk drive, Digital Video Disk (DVD) drive, compact disk (CD) drive, Redundant Array of Independent Disks (RAID), or tape drive.

After the connection is established between the initiator and the target, commands, data and status information encapsulated in frames are exchanged between the initiator and the target. Frames may be received in the same order that they are transmitted. A frame is a package of information transmitted as a single unit. The format of the frame and encapsulated information is defined by the protocol suite.

A SCSI storage element also referred to as a SCSI logical unit includes a logical unit number (LUN). The logical unit number which is stored in non-volatile memory in the SCSI logical unit is used to persistently identify the SCSI logical unit. Typically, 64-bits (8 bytes) are allocated for storing the logical unit number. Although 64-bits are allocated, all of the bits may not be used for all storage protocols.

The logical unit number may be accessed from the SCSI logical unit during the discovery process through the use of a SCSI Report LUN command which is a SCSI primary command and is defined in the ANSI T10 SCSI standards. Then the SCSI Inquiry command is used to obtain basic information from a target device and allows a host to discover the basic information associated with the target device. The SCSI Inquiry command may be used to determine the configuration of a logical unit with the logical unit responding with information that includes type, version of the standard used, vendor's identification, and model number. This information may be stored on the medium or in non-volatile memory in the target device.

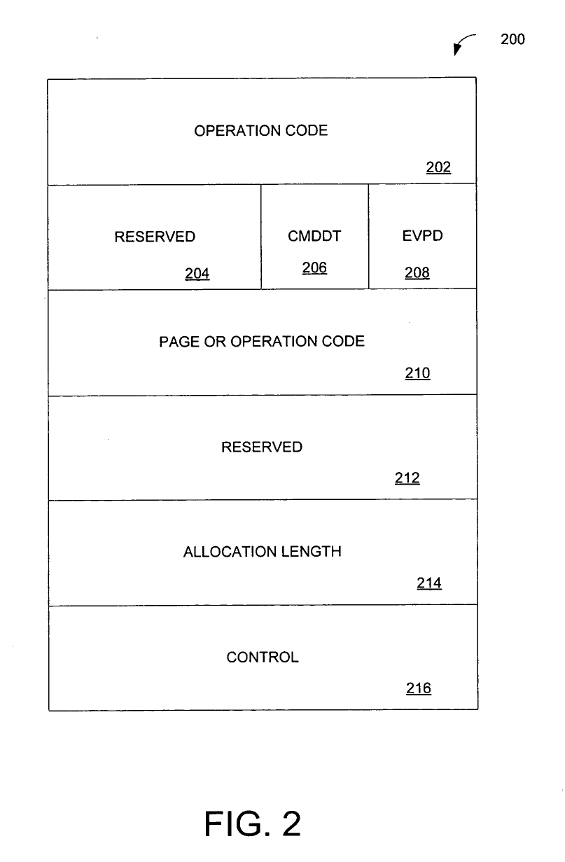

FIG. 2 is a block diagram illustrating the format of a SCSI Inquiry command. The SCSI Inquiry command is sent from a SCSI initiator to a SCSI target to request that the SCSI target return basic information associated with the SCSI target, for example, information about SCSI commands supported by the SCSI target.

The SCSI Inquiry command 200 shown in FIG. 2 is a six byte command that includes an operation code 202, a page code 210, an allocation length 214 and control 216. The operation code 202 identifies the SCSI command to be a SCSI Inquiry command. The state of the Enable Vital Product Data (EVPD) field 208 indicates whether vital product data specified by the page or operation code field 210 is requested. If the EVPD field 208 is zero, standard Inquiry data is returned in response to the SCSI Inquiry command.

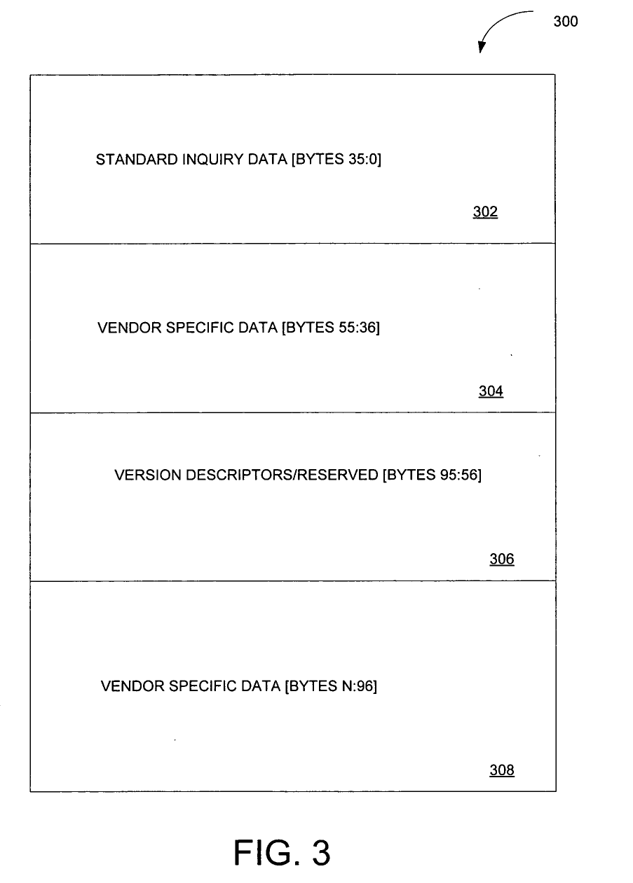

FIG. 3 is a block diagram illustrating the format of an embodiment of Inquiry data 300 returned by a target device in response to the SCSI Inquiry command. The Inquiry data 300 includes at least 36 bytes (bytes [35:0]) of standard Inquiry data 302. The first 36 bytes in the standard Inquiry data 302 includes the total number of bytes returned by the Inquiry command. The standard Inquiry data 302 also includes the peripheral device type, vendor identification, product identification, and product revision level of the target device. The Inquiry data 300 may include vendor specific data 304 stored in bytes 55:36 and bytes N:96.

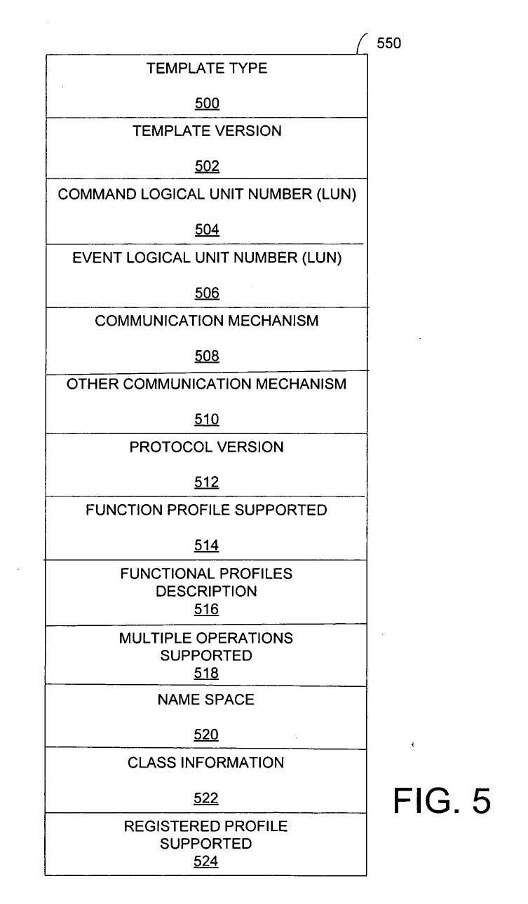

The vendor specific data field 308 is used to store management capabilities of the target device. The management capabilities will be described later in conjunction with FIG. 5.

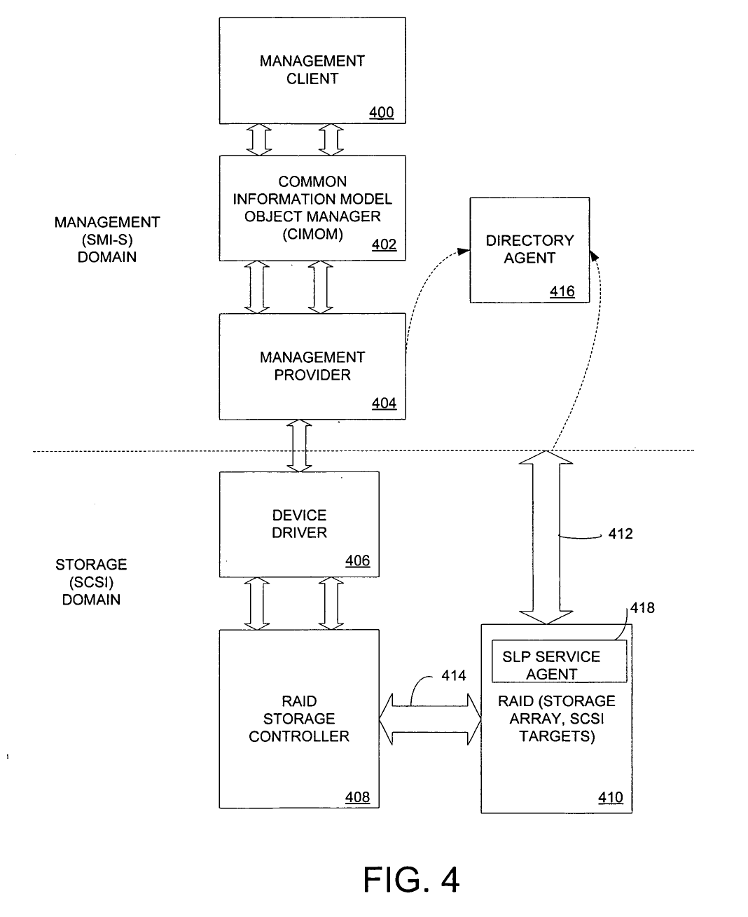

FIG. 4 is a block diagram illustrating in-band management and out-of-band management of an external RAID array 108 (FIG. 1) in a Small Computer Systems Interface (SCSI) domain. The management of the system 100 shown in FIG. 1 includes a Storage Management Initiative-Specification (SMI-S) management domain and a storage domain as shown in FIG. 4.

SMI-S defines an object oriented message based interface for controlling elements in a storage area network. SMI-S capabilities are defined by a hierarchy of object classes with properties and methods. The object oriented interface allows a client to discover, monitor, and control storage devices irrespective of the implementation of the storage devices.

In the SMI-S domain, identifiers of Common Information Model (CIM) instances are used to identify storage elements. In the storage domain, storage identifiers are used to identify storage elements. In one embodiment, the storage identifiers are SCSI logical unit number (LUN) identifiers defined by the SCSI standards. The SMI-S object model is based on the CIM. Web Based Enterprise Management (WBEM) also referred to as CIM/Extensible Markup Language (XML) over Hyper Text Transfer Protocol (HTTP) implements the messaging based interface. WBEM Clients are management clients that communicate with a Common Information Model Object Manager (CIMOM) using the CIM/XML/HTTP protocol suite.

In an embodiment, the SMI-S management domain includes a management client 400, a Common Information Model Object Manager (CIMOM) 402 and a management provider 404 in the host 102 of FIG. 1. The storage domain includes a device driver 406, a RAID Storage Controller 408 and RAID targets 410 in the RAID array 108 of FIG. 1. The management provider 404 performs a discovery process which involves the enumeration of all SLP targets and their management capabilities communicates with the storage target 410 through the HBA 110 (FIG. 1), and the device driver 406.

In another embodiment, the CIMOM 402 and management provider 404 may be in the RAID array 108 of FIG. 1.

The Service Location Protocol (SLP) is an IETF standards-track protocol that simplifies the discovery and use of network resources such as printers, web servers, fax machines, and storage devices such as RAID and tape drives. SLP is a packet-oriented protocol with packets transmitted using User Datagram Protocol (UDP) or Transmission Control Protocol (TCP).

The Service Location Protocol (SLP) allows devices to announce services on a local network allowing computers and other devices to find services in the local area network without the need for prior configuration. In the embodiment shown, a RAID array 410 includes an SLP service agent 418 that allows the RAID array 410 to announce services to an SLP directory agent 416.

The SLP service agent 418 includes at least one service. The service includes a Uniform Resource Locator (URL) that is used to locate the service. The service also includes a plurality of name/value pairs, called attributes. A service template includes the definition of a service, URL and allowed attributes. The service template is defined by IETF Request For Comments (RFC) 2609 and SLP is defined in Service Location Protocol, Version 2, both of which are available at www.ietf.org.

Instead, of providing the name of a network host (a human readable text string that is an alias for a network address) supporting a service, a description of the service (type of service and a set of attributes which describe the service) may be provided, for example, by an administrator (user) of the system through the management client 410. Based on the description, the Service Location Protocol resolves the network address of the service (through the management client).

The client 114 (FIG. 1) uses the SMI-S standard to manage storage elements such as the RAID array 108 (FIG. 1) in the SAN 104 (FIG. 1) using one or more objects defined by the SMI-S standard for the storage element. The SMI-S model is divided into several profiles. A profile describes a class of SAN entities, for example, a switch or a disk array. For example, SMI-S defines an array profile instance to describe an external RAID array.

The storage domain includes a device driver (HBA driver) 406 which is a device specific control program that enables operation with a particular device. In one embodiment, the device driver 406 enables operation with the RAID storage controller 408. The RAID storage controller 408 manages an array of hard disk drives in the RAID 410 using one of a plurality of serial storage protocols, for example, Serial Attached Small Computer System Interface (SAS) or Fibre Channel (FC).

A management client 400 is a process that runs in any one of the hosts 102 shown in FIG. 1. In an embodiment, the management client 400 may enable an administrator to configure and control the managed elements in the storage domain. The management client 400 issues management requests to perform operations on the managed elements. The management requests may identify the storage elements using their assigned SMI-S/CIM instance identifiers and identify the operations to be performed using SMI-S defined methods. For example, the management client 400 may be client 114 in host 102 shown in FIG. 1.

In an embodiment, the management client 400 may be a Web-Based Enterprise Management (WBEM) client that communicates with a Common Information Model Object Manager (CIMOM) 402 using the CIM/XML/HTTP protocol suite through a messaging interface. Through the messaging interface, the management client 400 issues management requests to the CIMOM 402.

The managed elements include a RAID array 410 which may be represented as a Common Information Model (CIM) object. The management client 400 communicates with the CIMOM 402 which manages CIM objects. The CIMOM 402 transfers information to a managed element through the management provider 404. The management provider 404 includes software drivers that interface managed elements with CIMOM 402, and enable their control using the management client 400.

In an embodiment, the CIMOM 402 is in the host 102 shown in FIG. 1. In response to a message received from the management client 400, the CIMOM 402 generates an SMI-S method for a CIM instance address associated with the managed element which is forwarded to the management provider 404.

Upon receiving a management request from the CIMOM 402, the management provider 404 performs the discovery process by issuing commands through the device driver 406 to the RAID array 410. One such command may be to obtain configuration data for the RAID array 410 which may be provided by the SLP service agent 418 in the RAID array 410.

The SLP service agent 418 includes SLP formatted data (SLP template) per storage device. For example, in the RAID array 410 shown in FIG. 4, there is one SLP template stored for each storage device in the RAID array. The SLP Formatted data is available both in-band through the SCSI Inquiry command and out-of-band through the SLP Protocol. An example of an SLP formatted data is shown in FIG. 5. In the embodiment shown, the SLP formatted data for a SCSI storage array (RAID array 410) includes the address of the SCSI LUN that responds to in-band SMI-S commands, and the address of the SCSI LUN that generates asynchronous SCSI events.

In the embodiment shown, each storage element in the RAID (storage array) 410 has a respective logical unit number. The logical unit number may be used to uniquely identify each storage element in the RAID array 410.

The management provider 404 also stores information for each storage element used by the device driver 406 to address the managed elements in an array of storage identifiers. This information includes a SCSI logical unit number (LUN) identifier associated with each managed element that uniquely identifies the storage element.

The management provider 404 uses the information retrieved from each logical unit number in the returned Inquiry data to manage the storage element in the SCSI domain.

The in-band transportation of the SCSI Inquiry data that includes the SLP service template is delivered to the management provider 404 through the device driver 406 and the RAID storage controller 408 over path 414 which may use a serial storage protocol such as Fibre channel or SAS to the SCSI target device in the RAID array 410.

The out-of-band mechanism for managing storage devices such as the external storage array is through the WBEM protocol and Ethernet physical links over path 412. The target device advertises its presence and manageability capabilities to the SLP directory agent 416. Management clients 400 discover the managed devices by querying the SLP directory agent 416. Discovery involves the retrieval of attributes such as TCP/IP address and port number of the managed device and this information is available in the SLP formatted data registered by the managed device with the SLP directory agent 416.

In the in-band mechanism, the SLP formatted data returned in the SCSI Inquiry response by the SLP service agent 418 may be stored by the management provider 404 in the SLP directory agent 416. Thus, the manageability capabilities retrieved from the target device using the in-band mechanism is available for managing the target device by the management provider 404.

The SLP template is a formal description of the SLP attributes and service scheme associated with SLP. The various attributes of the SLP Template are used to describe the in-band management capabilities of the SLP target device. Attributes are used to advertise the management capabilities of the target device. In one embodiment, the SLP template is returned in the SCSI Inquiry response in XML format. In anther embodiment the SLP template is in American Standard Code for Information Interchange (ASCII) format.

In another embodiment, the SLP formatted data (SLP template) may include both in-band and out-of-band attributes allowing all management attributes to be retrieved both in-band and out-of-band. Out-of-band attributes that may be included in the SLP template include the TCP/IP port that the target device listens on and the version of the web management application supported by the target device. In-band attributes that may be included in the SLP formatted data (SLP template) include the logical unit number through which the service is available. Thus, a device capable of both in-band and out-of-band management can advertise its capability in a synchronized and standardized manner.

In one embodiment, the attributes included in the SLP formatted data returned in the SCSI Inquiry command response data may include attributes for advertising a WBEM server. These attributes may include attributes that are defined in the “WBEM SLP template”, version 1.0 available at www.dmtf.org/standards/wbem/wbem.1.0.en

FIG. 5 is a block diagram illustrating an embodiment of an SLP template 550 that includes a plurality of attributes. The WBEM SLP template includes a template type 500 that includes the service type name, which may be ‘inband-wbem’ and a template version 502 that provides the version number of the service type specification. The SLP template 550 includes attributes that are used to describe both in-band and out-of-band management capabilities of a target device. The SLP template may be registered with the directory agent 416 (FIG. 4) by the target device RAID 410 or the management provider 404 (FIG. 4).

The command Logical Unit Number (LUN) field 504 specifies the 8 byte address of the LUN through which the ‘inband-wbem’ service is available. Although the target device is discovered through the SCSI Inquiry command, it is possible that the ‘inband-wbem’ service may be available at a LUN other than LUN 0. The event LUN field 506 specifies the 8-byte address of the LUN through which the ‘inband-wbem’ event service is available. The SCSI LUN stored in the command LUN field 504 is the LUN to which in-band management commands are sent, for example, in-band SMI-S commands. The event LUN field 506 stores the SCSI LUN that responds to SCSI commands such as, a SCSI Enclosure Services Command. In one embodiment the command LUN field 503 and the event LUN field 506 store different LUN numbers.

The WBEM server attributes may also include name and description of a CIM service for a human interface and an identifier for the WBEM server. The SLP template 550 also includes a communication mechanism (protocol) field 508 and other communication mechanism field 510 for storing the communication mechanisms used by a CIM object manager (CIMOM 402 (FIG. 4)), for example, XML or ASCII text format and a protocol Version field 512 for storing a version of the protocol. The functional profiles supported field 514 and functional profiles description fields 516 describe and list the CIM operation profiles and operations supported by the CIM object manager. The namespace field 520 is for storing namespaces supported on the target device. The class information field 522 is provided for storing class information (classes), that is, CIM schema version supported for the name spaces listed in the namespace attribute field 520. The registered profile supported field 524 indicates the profiles supported by the target device. The classes and profiles may be out-of-band attributes, that is, the same SLP template may describe both in-band and out-of-band attributes. For example, the SLP template may also include other out-of-band attributes such as TCP/IP address and port number.

The WBEM server registers its service and the attributes that accompany its service. A client application may display the service information in a user interface, for example, using the human readable information provided by the attributes.

Thus, the in-band mechanism for determining management capabilities of a managed element may be the similar to the out-of-band mechanism. That is, in-band discovery of device management capabilities is similar to the out-of-band discovery by retrieving the SLP formatted data in the response data returned from the SCSI Inquiry command. The need for a proprietary vendor unique implementation for in-band discovery of manageability capabilities is avoided through the use of standard SCSI supported and WBEM supported mechanisms. Furthermore, a single management provider may query the management capabilities of all devices that include SLP formatted data in the SCSI Inquiry command response data.

The management provider 404 (FIG. 4) may register devices that may only be managed in-band with the directory agent. For example, referring to FIG. 1 an embodiment of the target device 108 shown in FIG. 1 without a Network Interface Card (NIC) 118 could only be managed in-band through the storage area network 104 because there would be no access through the local area network 106. A service registration includes a service: URL and optionally a set of attributes.

The management provider 404 (FIG. 4) publishes the SLP formatted data as it is received from the target, that is, no translation of the SLP formatted data is required. Also, management clients 400 (FIG. 4) may discover devices that are managed both in-band and out-of-band.

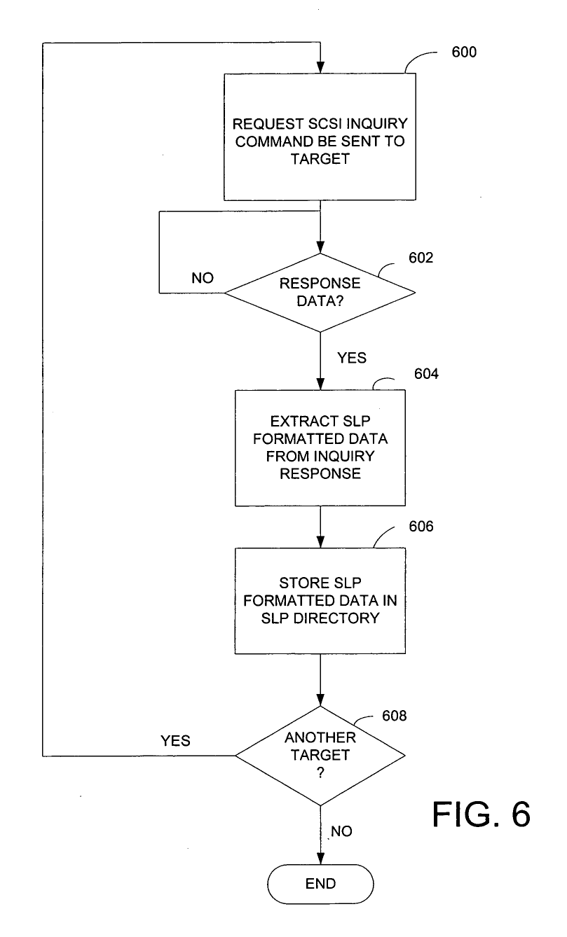

FIG. 6 is a flowchart illustrating an embodiment of a method for in-band discovery of device management capabilities according to the principles of the present invention. FIG. 6 will be described in conjunction with FIGS. 2-5.

At block 600, the management provider 404 requests capabilities of a discovered target device. A request to return capabilities of the target is issued to the SCSI domain which results in issuing a SCSI Inquiry command 200 (FIG. 2) to the target device. In one embodiment, the standard SCSI Inquiry command 200 described in conjunction with FIG. 2 may be used to discover the target device with the EVPD field 208 set to 1, the page or operation code field 210 set to C0 (hexadecimal) and the allocation length field 214 set to 96 bytes. If the target response data is more than 96 bytes, another SCSI Inquiry command may be issued with the appropriate allocation length. Processing continues with block 602.

At block 602, the management provider 402 (FIG. 4) waits for SCSI Inquiry response data 300 (FIG. 3) to be returned. The SCSI Inquiry response data 300 is returned to the SCSI domain from the target device and forwarded to the management provider 404 if the SCSI Inquiry command completes successfully. In one embodiment all of the SCSI Inquiry response data 300 may be returned to the management provider 404. The detection of the successful completion of the SCSI Inquiry command is handled by the SCSI domain and is beyond the scope of the present invention. Upon receiving SCSI Inquiry response data after a successful completion has been detected by the SCSI domain, processing continues with block 604.

At block 604, the management provider 404 receives the SLP formatted data 550 (FIG. 5) that has been extracted from the vendor specific data field 308 of the SCSI inquiry response data 300. In another embodiment the management provider 404 may extract the SLP formatted data from the returned SCSI Inquiry response data if all of the SCSI Inquiry response data is forwarded from the SCSI domain to the management provider 404. Processing continues with block 606.

At block 606, the management provider 404 stores the extracted SLP formatted data 550 in the SLP directory agent 416 for use by the management domain. Processing continues with block 608.

At block 608, the management provider 404 determines if there is another device for which management capabilities are to be retrieved. If so, processing continues with block 600. If not, processing is complete.

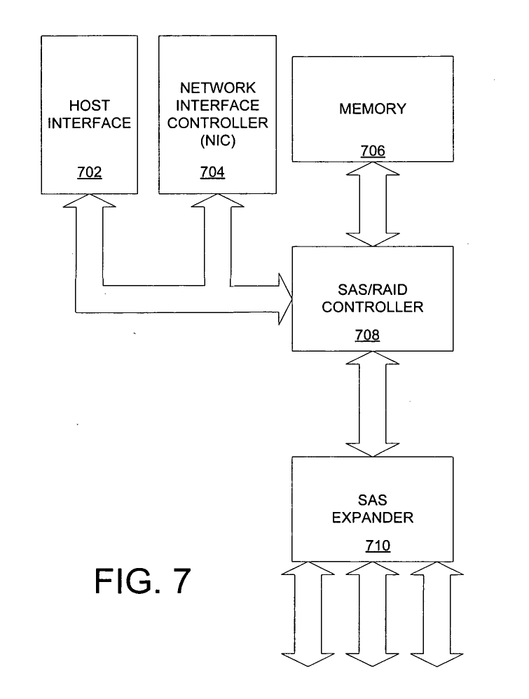

An embodiment of the invention has been described for a host bus adapter (HBA) in a computer system. An embodiment of the invention may also be provided in an embedded controller for a drive array as shown in FIG. 7. The drive array includes a plurality of storage devices which may be accessed through SAS or SATA drive ports via the SAS expander 710. A host interface 702 provides communication to a host system and a network interface controller 704 provides support for out-of-band management of the embedded controller. The host interface 702 may include the management provider 404, SLP directory agent 416 and SLP service agent 418 discussed in conjunction with FIG. 4.

In one embodiment the network interface controller 704 is a 1 Giga bit (Gb) Ethernet controller. The memory 706 is coupled to a SAS/RAID controller 708 for storing data used for implementing the RAID functionality.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, or a computer diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

1. An apparatus comprising:
a management provider to retrieve manageability capabilities of a managed device included in data returned in response to an in-band device capabilities discovery command issued to the managed device.

2. The apparatus of claim 1, wherein the management provider to perform in-band management of the managed device using the retrieved manageability capabilities.

3. The apparatus of claim 1, wherein the manageability capabilities are service location protocol (SLP) formatted attributes.

4. The apparatus of claim 1, wherein the in-band device capabilities discovery command is a Small Computer Systems Interface (SCSI) Inquiry command.

5. The apparatus of claim 4, wherein the manageability capabilities are stored in a vendor specific field of the SCSI Inquiry command response data.

6. The apparatus of claim 1, wherein the manageability attributes include a logical unit number for sending in-band management commands.

7. The apparatus of claim 1, wherein the manageability attributes include a type of encoding supported.

8. A method comprising:
retrieving manageability capabilities of a managed device included in data returned in response to an in-band device capabilities discovery command.

9. The method of claim 8, further comprising:
performing in-band management of the managed device using the retrieved manageability capabilities.

10. The method of claim 8, wherein the manageability capabilities are service location protocol (SLP) formatted attributes.

11. The method of claim 8, wherein the in-band device capabilities discovery command is a Small Computer Systems Interface (SCSI) Inquiry command.

12. The method of claim 11, wherein the manageability capabilities are stored in a vendor specific field of the SCSI Inquiry command response data.

13. The method of claim 8, wherein the manageability attributes include a logical unit number for sending in-band management commands.

14. The method of claim 8, wherein the manageability attributes include a type of encoding supported.

15. An article including a machine-accessible medium having associated information, wherein the information, when accessed, results in a machine performing:
retrieving manageability capabilities of a managed device included in data returned in response to an in-band device capabilities discovery command.

16. The article of claim 15, further comprising:
performing in-band management of the managed device using the retrieved manageability capabilities.

17. The method of claim 15, wherein the manageability capabilities are service location protocol (SLP) formatted attributes.

18. A system comprising:
a hard disk drive having a Serial Attached Small Computer System Interface (SAS) interface; and
a management provider to retrieve manageability capabilities of the hard disk drive included in data returned in response to an in-band device capabilities discovery command issued to the hard disk drive.

19. The system of claim 18, wherein the management provider to perform in-band management of the hard disk drive using the retrieved manageability capabilities.

20. The system of claim 18, wherein the manageability capabilities are service location protocol (SLP) formatted attributes.
